(19) United States
(12) Patent Application Publication
(10) Pub. No.: US 2004/0095507 A1
(43) Pub. Date: May 20, 2004

(54) Apparatus and method for capturing, processing and storing still images captured inline from an analog video stream and storing in a digital format on removable non-volatile memory

(75) Inventors: Anthony Martin Bishop, Carlsbad, CA (US); Michael Wayne Bishop, Lower Gwynedd, PA (US); Douglas Paton Taylor, Carlsbad, CA (US); Ben Wayne Stluka JR., Carlsbad, CA (US)

Correspondence Address: Anthony M. Bishop, 6841 Camino De Amigos, Carlsbad, CA, 92009, US

(73) Assignee: MediCapture, Inc., Carlsbad, CA

(21) Appl. No.: 10/712,573

(22) Filed: Nov. 13, 2003

Related U.S. Application Data
(60) Provisional application No. 60/427,096, filed on Nov. 18, 2002.

(51) Int. Cl. H04N 7/01; H04N 11/20

(52) U.S. Cl. 348/441

(57) ABSTRACT

An apparatus and method for capturing, processing still images, captured inline from an analog video stream, and storing in a digital format on removable non-volatile memory using an S-video or composite video interface to most medical modalities, including, ultrasound machines, intra-oral cameras, endoscopic cameras, or any device with analog video output. The apparatus provides a Menu Driven/Front Panel Control User Interface with on-screen messages providing the ability to review of images via unique On-Screen display. The apparatus utilizes on-board local memory with the ability to store images on multiple specialized non-volatile memory drives that can be equipped with unique embedded security key facilitating the storage, manipulation, and distribution of images. A preferred embodiment includes the capturing of images from live video to removable non-volatile memory formats utilizing the apparatus's video inputs without need of personal computer, and without the need for a computer bus interface.

### CROSS REFERENCE TO RELATED APPLICATIONS

This application claims the benefit of Provisional Patent Application Serial No. Nr. 60/427,096, Filed Nov. 18, 2002 by the present inventors

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Medical Imaging and more specifically to an apparatus and method for capturing, processing and storing still images captured inline from an analog video stream and storing in a digital format on removable non-volatile memory.

Medical Video became a common accessory in medical imaging in the early 1980s. Companies of medical imaging devices such as ultrasounds and endoscopes recognized the demand for surgeons to document their work for whatever reason that was important to the surgeon. Surgeons often dictate what a hospital is to buy based on their egos wants and needs. Since they generate the most income for the hospital they have a lot of “pull”. Medical device manufactures had to comply to remain competitive and hold their market share. Industrial divisions of large consumer conglomerates such as Sony Panasonic and Mitsubishi began to market higher cost rugged medical grade devices that would interface with medical devices in ways that consumer products could not comply.

First Devices were video monitors to be used as external display devices, technology had to be better than what was available on the consumer market to be able to show the detail and contrast that the surgeon or diagnostic tech was used to seeing on thru their optics or film

VCRs became a popular low cost type of media to document and record the surgery, the surgeons expressed a more effective way to be able to make post op notes after the procedure or to use in instruction. Editing equipment followed but is utilized after the procedure to streamline and edit a presentation to aid the surgeon in teaching their pioneering methods of surgery.

Still Image Recorders—Frame recorders were adapted to medical use since many surgeons and dentist wanted only a few still images from a case and preferred not to record the whole surgery for liability purposes.

Video Printers—Dye sublimation printers are popular in medical imaging because they can freeze a video frame and print a photo like quality image a glossy media.

1 CCD and 3CCD cameras are used in intra-oral cameras to endoscopes. This offered the surgeon a more effective tool for surgery since it can display a larger high resolution image on a screen rater than having to look through an eyepiece. Small high resolution cameras revolutionized the surgical procedures allowing less evasive procedures.

As the medical community continues to increase its use of digital imaging, the need for high-capacity, affordable ways to store and manage digital information becomes urgent. Choosing the right type of information storage system can improve the information flow of any healthcare organization, especially one where the speed of access to information is crucial. The traditional record types, paper and film, have seen a sharp decline in usage due to the fact that they take up a lot of space, are time-consuming to search through, and are difficult to access and share across distances. Even so, they have remained important, particularly as display mechanisms. The medical community is crying out for a removable media storage solution to evolve towards a more of a paperless society.

Removable Non-volatile memory, the newest class of data storage options, includes USB memory drives, CompactFlash etc. Removable Non-Volatile memory storage is extremely small and portable, and store up to 1 GB of data each. A highly detailed medical image can be stored electronically in 20 MB with lower resolutoin images requiring 500K-1 MB per image or less allowing the storage of 50 highly detailed images or approx 1000 standard lower resolution images.

My Medical Image Device is designed to be backwards compatible with all medical imaging modalities utilizing video, providing digital still images quickly and in an extreemly cost effective manner to the medical community. It can work in conjunction with all video devices past and present. My product will solve the shortfall of most medical imaging modalities; digitization and manipulation of patient images via computer.

### BRIEF SUMMARY OF THE INVENTION

The primary object of the invention is to capture and store images from medical imaging devices utilizing analog video stream on a removable non-volatile memory devices (ex. USB memory drives).

Another object of the invention is interface via S-video or composite video (BNC connector) inline to most medical modalities, including; ultrasound machines, intra-oral cameras, endoscopic cameras, or any device with analog video output.

Another object of the invention is to meet the needs and requirements of medical video imaging applications.

A further object of the invention is to provide still images on removable non-volatile memory storage compatible with a majority of Personal Computers without the need for special drives or adapters, that are robust, sealed and protected unlike floppy drives of CDROMS and without any moving parts.

Yet another object of the invention is to meet the need of the medical imaging industry's need to go “paperless”.

Another object of the invention is to capture and store images to removable non-volatile memory devices media that has lower read/write failure rate, and allows for media storage within multiple sessions on same device, unlike write once/read many CDROM media.

Still yet another object of the invention is to store images to removable non-volatile memory devices media allowing device users to easily export images to personal computer to for medical record management, or Patient novelty (for example, sonogram images), or.

Another object of the invention is to utilize removable non-volatile memory devices media technology in the medical marketplace as the advance rate has driven a market decrease in price and in increase in memory size. Currently removable non-volatile memory devices media storage sizes are widely available up to 1 GB.

Another object of the invention is to provide image capture technology in the medical marketplace via removable non-volatile memory devices media which is among the fastest storage and archival media within all non-volatile information storage (including paper, film, NVM, Optical, Magnetic and Magneto Optical Media).

A further object of the invention is to provide technology in the medical marketplace that incorporates simple user interface with On-screen display operational messages, and one button capture and export to removable non-volatile memory devices media.

Yet another object of the invention is to provide technology in the medical marketplace that incorporates quick and simple installation, “plug and play” type application, no complicated networking involved. Product requires power cable and video in/out only.

Still yet another object of the invention is to provide technology in the medical marketplace that is designed for market longevity.

Another object of the invention is to provide technology in the medical marketplace that incorporates “High tech” and “Robust” look and feel for medical industry market acceptance in medical imaging.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus and method for capturing, processing and storing still images captured inline from an analog video stream and storing in a digital format on removable non-volatile memory which comprises: an interface via S-video or composite video inline to most medical modalities, including, ultrasound machines, intra-oral cameras, endoscopic cameras, or any device with analog video output providing the ability to capture still images from an analog video stream, provide a live picture pass thru, visual and audible verification of image capture, providing a user selectable preview function that displays images via unique on-screen display, supporting underscan video mode to provide a means to capture patient data from medical imaging devices, utilizing user selectable PAL/NTSC video formats to ensure compatibility within international marketplace, using video capture circuitry designed to be of a quality to meet a medical imaging application, providing a Menu Driven/Front Panel Control User Interface with on-screen messages and review of images via unique On-Screen display, utilizing on-board local memory with the ability to store images on multiple removable non-volatile memory devices, providing Logic Processor interfaces between video capture circuitry and removable non-volatile memory devices in a unique manner to store images on multiple images on removable non-volatile memory devices, and saving said images to specialized non-volatile memory drives that can be equipped with specialized embedded security key facilitating the storage, manipulation, and distribution of images (conforms to medical digital imaging standards).

### BRIEF DESCRIPTION OF THE DRAWINGS—FIGURES

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a frontal plan view of the invention.

FIG. 2 is a rear plan view of the invention.

FIG. 3 is a schematic block diagram of a typical video system configured in the method to use S-VHS video cables.

FIG. 4 is a rear plan view with schematic block diagram of the invention configured in the method to use S-VHS video cables.

FIG. 5 is a schematic block diagram of a typical video system configured in the method to use Composite video cables.

FIG. 6 is a rear plan view with schematic block diagram of the invention configured in the method to use Composite video cables.

FIG. 7 is a schematic block diagram of the data processing of the system.

FIG. 8 is a computer rendering of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

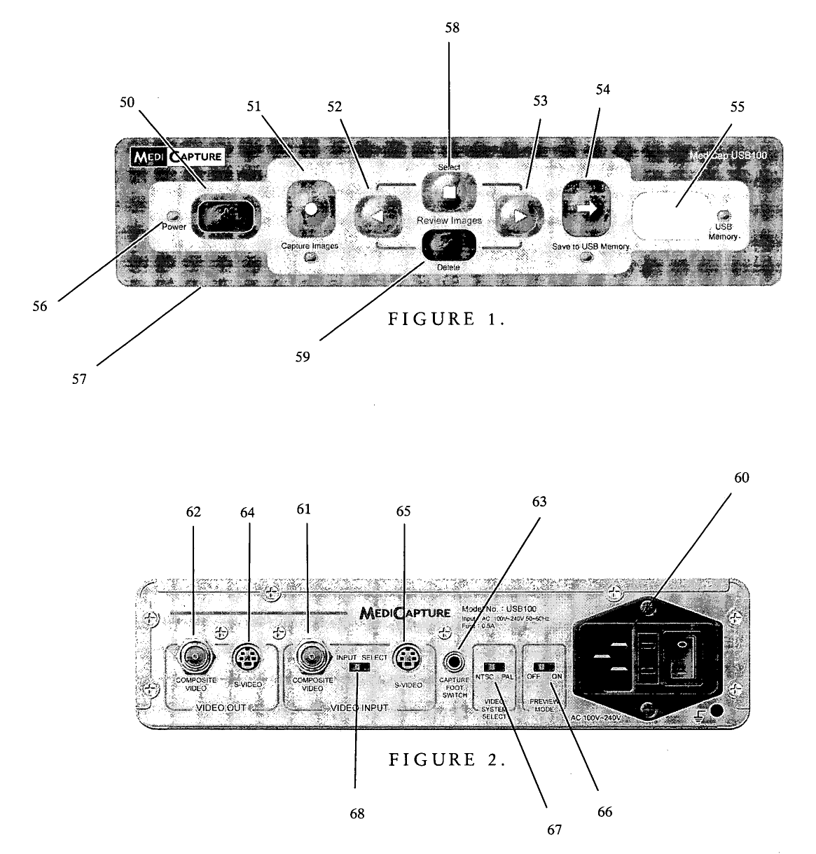

In accordance with the present invention, FIG. 1, shows a frontal pan view of a basic view of my medical imaging device. The Medical Imaging device is used for capturing, processing and storing still images captured inline from an analog video stream and storing in a digital format on removable non-volatile memory. The medical imaging device frontal pan view, FIG. 1, consists of an operational front panel of buttons referenced as Reference numbers 50-59.

Reference Number 50 refers to the Power On/Off Button 50. Power On/Off Button 50 is software programmed button used to power down the apparatus unless images remain on the internal memory storage of the unit, at which time the user is presented with an On-Screen display of options as described in the Power Off sequence mode of this document.

Reference Number 51 refers to the Image Capture Button 51. Capture Button 51 is software programmed button used to capture a frame of the current video stream in any state except the exporting of images.

Reference Numbers 52 and 53 refers to Review Images Button Left 52 and Review Images Button Right 53. Review Images Button Left 52 and Review Images Button Right 53 buttons are software programmed buttons used to enter and 1) review images stored in local memory, 2) review images immediately after being stored in Removable non-volatile memory, or 3) Move cursor in On Screen Display to select Menu items

1) In any state except the exporting of images and the reviewing of images, pressing either the Review Images Button Left 52 or Review Images Button Right 53 Review button enters Review Mode. Pressing either the Review Images Button Left 52 or Review Images Button Right 53 in this review mode moves from current image to next image stored in memory.

2) Once images have been exported to Removable non-volatile memory drive the user will be presented with options to Export to another Removable non-volatile memory device, Review images on current Removable non-volatile memory device or End Session deleting images stored locally. Selecting Review images on Removable non-volatile memory Device enters Removable non-volatile memory Image Review Mode, showing all images stored on Removable non-volatile memory device from most recent session. Pressing either the Review Images Button Left 52 or Review Images Button Right 53 in this review mode moves from current image to next image stored in memory.

3) When the On-Screen Display menu displays choices for the user to select from the Review Images Button Left 52 and Review Images Button Right 53 Review buttons Move the Cursor to select from the options available.

Reference Number 54 refers to Export Images Button 54. Export Images Button 54 is software programmed button used to Export images stored in local memory to attached removable non-volatile memory drive located in the Removable non-volatile memory port 55.

Reference Number 55 refers to Removable non-volatile memory port 55. Removable non-volatile memory port 55 provides location for the interface between apparatus and non-volatile memory drive (example: USB Memory device)

Reference Number 56 refers to Status LED 56. Status LED 56 indicator providing Power status of apparatus.

Reference Number 57 refers to Rugged Metal Case 57. Rugged Metal Case 57 is designed to be used in industrial applications such as Medical Operating Room

Reference Number 58 refers to Select Button 58. Select Button 58 is software programmed button used to Select Menu features being presented on the internal software On-Screen Display

Reference Number 59 refers to Delete Button 59. Delete Button 59 is software programmed button used to delete images selected on video monitor On-Screen Display

Turning now to the drawings referenced as FIG. 2 shows a rear pan view of a basic view of my medical imaging device. The medical imaging device rear pan view, FIG. 2, an operational rear panel of connectors and switches referenced as numbers 60-68

Reference Number 60 refers to AC Power Plug 60. AC Power Plug 60 provides power to the apparatus via 3 prong AC plug

Reference Number 61 refers to Composite Video Input 61. Composite Video Input 61 is a Composite video BNC jack, providing Video in. Composite Video Input 61 is a NTSC/PAL composite video 1 Vp-p type connector. Composite Video Input 61 purpose is to provide input from video stream

Reference Number 62 refers to Composite Video Output 62. Composite Video Output 61 is a Composite BNC jack providing Video out. Composite Video Input 62 is a NTSC/PAL composite video 1 Vp-p Type connector. Composite Video Output 62 purpose is to provide output of video stream, and preview of still images as necessary.

Reference Number 63 refers to Foot Switch Input 63. Foot Switch Input 63 is a 3.5 mm Mini pin jack, supporting a typical Contact Closure foot switch: supporting separate foot switch necessary for hands free operation.

Reference Number 64 refers to S-VHS Video Input 64. S-VHS Video Input 64 is an S-Video mini-DIN4 type connector. S-VHS Video Input 64 provides S-VHS video in NTSC/PAL format. S-VHS Video Input 64 purpose is to provide input from video stream

Reference Number 65 refers to S-VHS Video Output 65. S-VHS Video Output 65 is an S-Video mini-DIN4 type connector. S-VHS Video Output 65 provides S-VHS video out in NTSC/PAL format. S-VHS Video Output 65 purpose is to provide output of video stream, and preview of still images as necessary.

Reference Number 66 refers to Preview Images On/Off Switch 66. Preview Images On/Off Switch 66 enables the previewing and displaying images as captured, via video out source.

Reference Number 67 refers to PAL/NTSC Select Switch 67. PAL/NTSC Select Switch 67 selects the Video mode of the apparatus; PAL or NTSC format

Reference Number 68 refers to Video Select Switch 68. Video Select Switch 68 selects the video signal mode of the apparatus; Composite of S-Video format

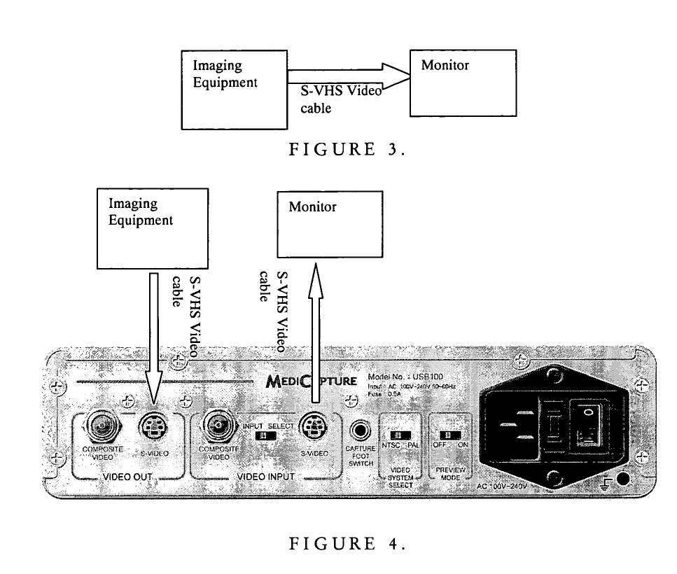

Turning now to the drawings referenced as FIG. 3 shows a typical example of a video system configuration using S-VHS cables. This reference is used only to illustrate the configuration of my medical imaging device within a typical S-VHS configuration usage as referenced in FIG. 4. The medical imaging device rear pan view, FIG. 4, shows an illustration of the proper configuration using S-VHS video cables. Configured in this method the Medical Imaging Device will interface via S-video video (mini-DIN4) inline to ultrasound machines, intra-oral cameras, endoscopic cameras, or any device with analog video output. The Medical imaging Device Captures and stores digital still images on command from data stream carried over S-VHS video cable provided by the output of imaging equipment. The Medical imaging device allows on-screen review of images captured and stored on the apparatus via unique on-screen display provided by the output of the S-VHS video cable attached to the apparatus. The Medical imaging Device will allow video to pass through S-video video cable to a video monitor unaltered, until images are captured by user, at which time providing a visual verification of image capture via attached S-video output cable. Images captured by the Medical Imaging Device are stored on removable non-volatile memory devices that can be equipped with a specialized embedded security key regardless of video cable used, allowing users to easily export images to a removable non-volatile memory device to share with family and friends (for example, sonogram images)

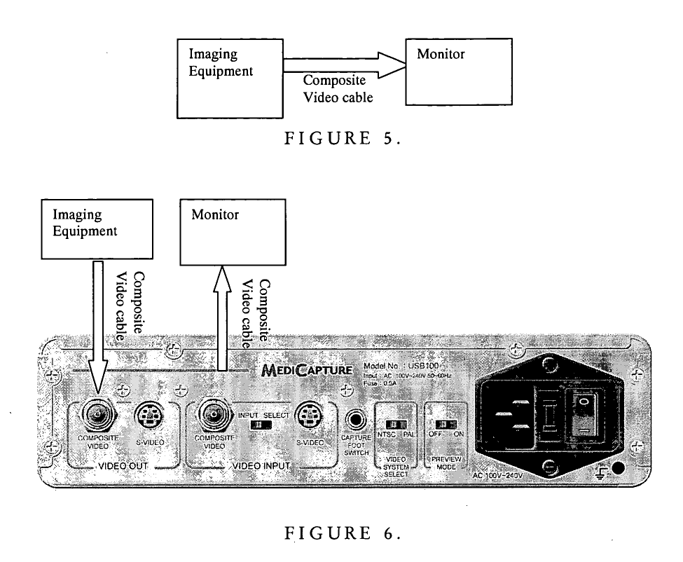

Turning now to the drawings referenced as FIG. 5 shows a typical example of a video system configuration using Composite video cables. This reference is used only to illustrate the configuration of my medical imaging device within a typical composite video cable configuration usage as referenced in FIG. 6. The medical imaging device rear pan view, FIG. 6, shows an illustration of the proper configuration using Composite video cables. Configured in this method the Medical Imaging Device will interface via Composite video (BNC connector) inline to ultrasound machines, intra-oral cameras, endoscopic cameras, or any device with analog video output. The Medical imaging Device Captures and stores digital still images on command from data stream carried over composite video cable provided by the output of imaging equipment. The Medical imaging device Allows on-screen review of images captured and stored on the apparatus via unique on-screen display provided by the output of the composite video cable attached to the apparatus. The Medical imaging Device will allow video to pass through composite video cable to a video monitor unaltered, until images are captured by user, at which time providing a visual verification of image capture via attached composite output cable. Images captured by the Medical Imaging Device are stored on removable non-volatile memory devices that can be equipped with a specialized embedded security key regardless of video cable used, allowing users to easily export images to a removable non-volatile memory device to share with family and friends (for example, sonogram images)

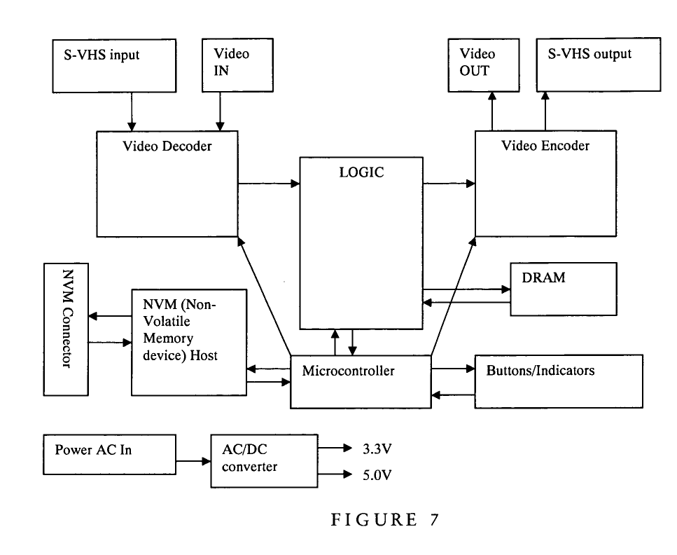

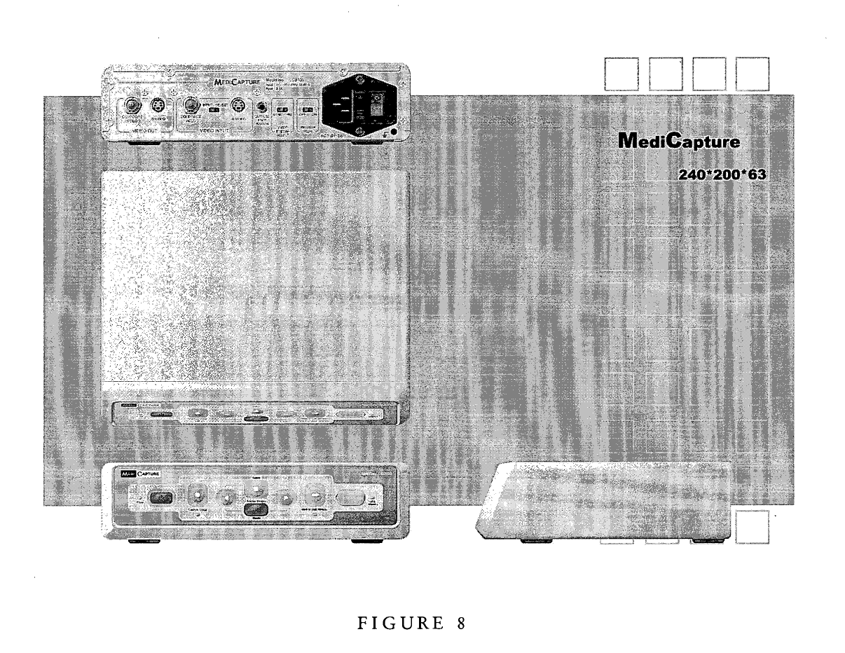

Turning now to the drawings referenced as FIG. 7 shows a schematic block diagram in a basic configuration of my medical imaging device. The Medical Imaging Device uses readily available microcontrollers, memory, video encoders, video decoders, and non-volatile memory controllers, configured in a method to create a unique video still image capture device that stores data on a removable non-volatile media device (eg. USB memory drives)

The medical Imaging device operation is controlled by a unique and custom Graphic user interface that is displayed via video monitors that physically attached to S-VHS Video Output 65 or Composite Video Output 62 with the necessary video cables. This unique graphic user interface that is a text-based user interface is provided via the on-screen display (OSD). The on-screen display video signal is displayed via S-VHS Video Output 65 and/or Composite Video Output 62, and overlaid on the attached video monitor screen. The On-screen display provides basic information such as image number, prompts to export images, and delete images stored locally. These messages are displayed while in specific modes or via error messages in any mode. The Medical Imaging Device software modes consist of the following;

1. Live Video Mode

This is the default mode when the box is powered on. Incoming video from S-VHS Video Input 64 and/or Composite Video Input 61 is routed directly to S-VHS Video Output 65 and/or Composite Video Output 62, and displayed on the attached video monitor screen.

No on-screen display is shown.

2. Capture Mode (Still Image Stored into DRAM and Displayed for Previewing if Preview Images On/Off Switch 66 is Set to ON.

An incoming video still image frame from S-VHS Video Input 64 and/or Composite Video Input 61 video feed is stored into DRAM (two half-frames: 2×780×260×16 bits are stored). Sufficient DRAM size/configuration is available to store and process multiple images locally within the Medical Imaging Device. Video out displays image in DRAM as a still picture (if Preview Images On/Off Switch 66 is set to ON). A number (nnn=0-999) is assigned to the image currently stored in DRAM. The image number is displayed to video out for 3 seconds while the image number is displayed by the on-screen display as NNN (if Preview Images On/Off Switch 66 is set to ON). Then Live Video mode resumes. If rear Preview Images On/Off Switch 66 switch is set to Mode OFF images are NOT previewed to S-VHS Video Output 65 and/or Composite Video Output 62 video out, but written directly to local memory without interfering with live Video feed on display.

During the Capture Images mode the User Interface displays an On-Screen navigation to guide the user to the proper selection. This On-screen navigation is described as follows: Images can be captured and stored to local memory with our without a Removable non-volatile memory drive installed in Removable non-volatile memory port 55. If a Removable non-volatile memory drive is installed in Removable non-volatile memory port 55, and images have NOT yet been exported AND Removable non-volatile memory drive is removed the Medical Imaging Capture device will beep a set number of times, and the OSD will indicate “IMAGES NOT STORED ON REMOVABLE NON-VOLATILE MEMORY DEVICE. PLEASE REINSERT REMOVABLE NON-VOLATILE MEMORY DRIVE AND PRESS THE EXPORT BUTTON”Pressing Image Capture Button 51 if the Preview Images On/Off Switch 66 is turned on shows current image being captured for 3 seconds on OSD with Image number displayed in bottom right corner of display. Pressing Image Capture Button 51 does not show anything on OSD if Preview Images On/Off Switch 66 is set to off.

3. Export Images Mode (Writing to Removable Non-Volatile Memory Device)

Images are stored in device local memory until Export Images Button 54 is pressed. When Export Images Button 54 is pressed all images in local memory are exported to the removable non-volatile memory inserted in the Removable non-volatile memory port 55. Once all images are exported the user is presented with 3 options: export images to another removable non-volatile memory device, review images on removable non-volatile memory or end session to delete stored memory. Pressing Review Images Button Left 52 and Review Images Button Right 53 selects the available options displayed on the OSD, while pressing the Export Images Button 54 again exports the images to another removable non-volatile memory device. When End session to delete storage is selected the user is prompted by a warning indicating “That ending session will delete all images stores locally, please remove your removable Non-volatile memory drive now and press the Enter button to power down”, pressing Enter Button 58 deletes locally stored images.

During the Export Images mode the User Interface displays an On-Screen navigation to guide the user to the proper selection. This On-screen navigation is described as follows: If the Export Images Button 54 is pressed and a Removable non-volatile memory device with sufficient space to store all images contained in the Medical Imaging Device's local memory, the OSD will display a message indicating that “Images exporting to Removable non-volatile memory drive. Please wait until complete to remove Removable non-volatile memory drive”. A process bar displayed on the OSD will indicate percentage done.

If a Removable non-volatile memory device is installed in Removable non-volatile memory port 55 without sufficient space the OSD will indicate that “Removable non-volatile memory device does not have sufficient space to store all images. Please insert new Removable non-volatile memory drive and try again”If no Removable non-volatile memory device is installed in the Removable non-volatile memory port 55 and Export Images Button 54 is pressed the OSD will display a message indicating that “No Removable non-volatile memory drive present. Please insert a Removable non-volatile memory drive with sufficient space and export again” Once the Exporting of Images is complete the OSD will display 3 options: Export to another Removable non-volatile memory Drive, Review Images recently Stored on Removable non-volatile memory drive, and Exit Session deleting images stored on internal memory. Pressing the Review Images Button Left 52 and Review Images Button Right 53 selects the available options.

4. Review Mode (View Images Stored in Flash Memory)

There are two Review buttons: Review Images Button Left 52 and Review Images Button Right 53. Pushing either button enters the Review mode and displays the most recent image that was saved to the Device internal memory. While the image is displayed, the image number is displayed by the on-screen display. The image is displayed until either Review Images Button Left 52 and Review Images Button Right 53 is pressed (displaying the next or previous image stored in memory) or the Image Capture Button 51 is pressed (entering Live Video mode). While in Review mode, when the last stored image is displayed, pressing the Review Images Button Right 53 will display the first image. Likewise, when the first stored image is displayed, pressing the Review Images Button Left 52 will display the last stored image. In other words, the navigation is “circular.”

5. Power Off Mode (Powers Down Medical Imaging Device Unless Device is in Specific State of Operation) When the Power On/Off Button 50 is pressed and images remain on the internal memory and have not been stored to Removable non-volatile memory the unit will NOT power off and the OSD will display the message “Images not yet stored to Removable non-volatile memory media drive. Powering off unit without exporting will erase all images stored locally” “Press Power Off Again to power down unit and erase internal memory or press Export to store images to Removable non-volatile memory” Pressing Power On/Off Button 50 a second time will Power off the unit. Pressing the Export Images Button 54 will exit power off sequence and begin export sequence.

Pressing Power On/Off Button 50 after images have been exported and without any images in local memory immediately powers down unit.

The operational flow chart of the Medical Imaging Capture device modes describes the operation necessary to enter and exit certain modes. This operation is described as follows: Live Video mode→press Image Capture Button 51→next image stored into Medical Imaging Device memory with a “beep” confirmation. Video output is not interrupted. There is no on-screen display with Preview Images On/Off Switch 66 set to OFF; and an overlay of the image stored on the on-screen display with Preview Images On/Off Switch 66 set to ON; A typical foot switch accessory attached to Foot Switch Input 63 activates the Capture functionality in the same method as the Image Capture Button 51.

Press Export Images Button 54→User is presented with options to store images into Removable non-volatile memory. Images are then exported to Removable non-volatile memory. Once export is complete user is prompted to export to another device, review images on Removable non-volatile memory device or End Session deleting stored images→Live Video mode resumes. Pressing Image Capture Button 51 at this state captures new image and returns to Live Video mode.

The Medical Imaging device has local memory in order to store same images on multiple Removable non-volatile memory devices. The export images function can be accessed while the user is reviewing images or immediately when complete recording images. Images are stored on Removable non-volatile memory in subdirectories created at the time of export. Subdirectories are named sequentially, starting with MedicapImages01 at the Removable non-volatile memory media root at the end of each session. If MedicapImages01 directory is present, MedicapImages02 subdirectory is created, etc. Images are stored by the file names are defined in the image capture section in the most recently created directory on the removable non-volatile memory drive.

Reviewing Saved Images:

In any mode→press either the Review Images Button Left 52 or Review Images Button Right 53 buttons→most recently stored image from Medical Image Capture Device memory is displayed to video out while the image number (NNN) is displayed by the on-screen display. Image continues to be displayed until a Review Images Button Left 52 and Review Images Button Right 53 is pressed again (displaying the next or previous image) or the Image Capture Button 51 is pressed (storing a new image and bringing video display back to live video mode)

Thus the reader will see that the Medical Imaging Device of the invention provides a highly reliable, user friendly, robust Imaging device that can be operated by persons of almost any age.

While my above description contains many specificities, these should not be constructed as limitations on the scope of the invention, but rather as an exemplification on one preferred embodiment thereof.

Many other variations are possible. For example the Medical Imaging device would be equipped with the necessary functionality to record a live video stream and store on the Removable non-volatile memory drive.

Variations of the Medical Imaging Capture Device will incorporate alternative Removable non-volatile memory devices consisting of USB memory drives, Compact Flash drives PCMCIA memory storage drives, Firewire memory drives, and other types of non-volatile memory storage devices while having similar and alternative methods of connecting the Removable non-volatile memory devices to the Medical Imaging Device.

Variations of the Medical Imaging Capture Device will incorporate alternative storage media such as Optical (eg. CDROM, CDRW, DVDROM), Magnetic (eg. Tape drive, floppy drive) or Magneto Optical as a removable memory device.

In addition variations of the Medical Imaging Device can be connected to it's adjacent elements in a different manner. For example, RGB video connections, Component video, RCA Composite video connections and other types of widely available analog and digital formats of video cables.

Additionally variations of the Medical Imaging Device may have an alternative user interface, or button functions and locations.

In addition variations of the Medical Imaging Device may be made of alternative, materials, in different colors, or be made in different shapes and sizes.

Accordingly, the scope of the invention should be determined not by the embodiments illustrated, but by the appended claims of their legal equivalents.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus and method for capturing, processing and storing still images captured inline from an analog video stream and storing in a digital format on removable non-volatile memory which comprises:
an interface via S-video or composite video inline to most medical modalities, including; ultrasound machines, intra-oral cameras, endoscopic cameras, or any device with analog video output providing the ability to capture still images from an analog video stream, provide a live picture pass thru, visual and audible verification of image capture;
providing a user selectable preview function that displays images via unique on-screen display;
supporting underscan video mode to provide a means to capture patient data from medical imaging devices;
utilizing user selectable PAL/NTSC video formats to ensure compatibility within international marketplace;
using video capture circuitry designed to be of a quality to meet a medical imaging application;
providing a Menu Driven/Front Panel Control User Interface with on-screen messages and review of images via unique On-Screen display;
utilizing on-board local memory with the ability to store images on multiple removable non-volatile memory devices;
providing Logic Processor interfaces between video capture circuitry and removable non-volatile memory devices in a unique manner to store images on multiple images on removable non-volatile memory devices; and
saving said images to specialized non-volatile memory drives that can be equipped with specialized embedded security key facilitating the storage, manipulation, and distribution of images (conforms to medical digital imaging standards).

2. The invention as claimed in claim 1 wherein the capturing of images from live video to removable non-volatile memory formats utilizes the apparatus video inputs comprises without need of personal computer, and without the need for a computer bus interface.

3. The invention as claimed in claim 1 wherein said video functionality comprise;
a wide range of video frequencies to ensure compatibility with the majority of medical imaging equipment; and
utilizing underscan to provide a means to capture patient data from medical imaging devices.

4. The invention as claimed in claim 1 wherein providing the ability to make available hands free operation via typical contact closure footswitch to capture still images.
